(19) United States
(12) Patent Application Publication
(10) Pub. No.: US 2015/0058363 A1
(43) Pub. Date: Feb. 26, 2015

(54) CLOUD-BASED ENTERPRISE CONTENT MANAGEMENT SYSTEM

(71) Applicant: ROBERT LANCER, MELVILLE, NY (US)

(72) Inventor: ROBERT LANCER, MELVILLE, NY (US)

(21) Appl. No.: 14/465,129

(22) Filed: Aug. 21, 2014

Related U.S. Application Data
(60) Provisional application No. 61/868,189, filed on Aug. 21, 2013.

(51) Int. Cl. G06F 17/30

(52) U.S. Cl. CPC G06F 17/30477
USPC 707/749

(57) ABSTRACT

According to an exemplary embodiment of the invention, a database system includes a memory storing a computer program; a processor configured to execute the program, and a database. The database comprises a tree graph, where the tree graph is a tree that comprises a plurality of nodes. Each node includes a literal identifier (ID) that refers to an instance of one of a plurality of types of data structures and a node ID that uniquely distinguishes the node from the remaining nodes in the tree. The program is configured to receive a query from a user comprising one of the instances, process the query by traversing the tree to each node having a same literal ID that corresponds to the instance in the query, and generate a query result based on children nodes of each node traversed to.

### CROSS-REFERENCE TO RELATED APPLICATIONS

This application claims priority to U.S. Provisional Application No. 61/868,189 filed on Aug. 21, 2013, the disclosure of each is incorporated by reference herein.

### BACKGROUND

1. Technical Field

The present disclosure relates generally to a cloud-based enterprise content management system, and more particularly to a cloud-based enterprise content management system using a tree-based database.

2. Discussion of Related Art

Cloud computing is the delivery of computing as a service rather than a product, whereby shared resources, software, and information are provided to computers and other devices as a utility over network (e.g., the Internet). Clouds can be classified as public, private, or hybrid. A private cloud is a cloud infrastructure operated solely for a single organization, whether managed internally or by a third party, and hosted either internally or externally. A public cloud occurs when the services are rendered over a network that is open for public use. A hybrid cloud is a composition of two or more clouds (e.g., a private and a public cloud, two public clouds, etc.).

A typically cloud computing service enables users to store their content remotely in a database (e.g., a relational database). The software for a relational database is called a Relational Database Management System (RDBMS), which controls reading, writing, modifying, and processing information stored therein. Each database is a collection of related tables. Each table is a physical representation of an entity or object that is in a tabular format consisting of columns and rows. Columns are the fields of a record or the attributes of an entity. The rows contain the values or data instances, which are referred to as records or tuples.

However, in a relational database, all the data is stored without context. Relationships are expressed by non-trivial relationships among tables. Further, it becomes exceedingly difficult to track complex relationships as is necessary in the enterprise environment. Moreover, the data is not in its most natural form, making manipulation unintuitive. While a relational database may be suitable for manipulating data within tables, it is not suitable for more advanced set theory operations and the handling of complicated dynamically changing relationships.

Thus, there is a need for a cloud-based enterprise management system, which can store data with context.

### SUMMARY

According to an exemplary embodiment of the invention, a database system includes a memory storing a computer program; a database including a tree graph, where the tree graph is a tree having a plurality of nodes, wherein each node includes a literal identifier (ID) that refers to an instance of one of a plurality of types of data structures and a node ID that uniquely distinguishes the node from the remaining nodes in the tree; and a processor configured to execute the program. The program is configured to: receive a query from a user comprising one of the instances; process the query by traversing the tree to each node having a same literal ID that corresponds to the instance in the query; and generate a query result based on children nodes of each node traversed to.

According to an exemplary embodiment of the invention, a method of performing a query on a database including a tree graph is presented, where the tree graph is a tree having a plurality of nodes, wherein each node includes a literal identifier (ID) that refers to an instance of one of a plurality of types of data structures and a node ID that uniquely distinguishes the node from the remaining nodes in the tree. The method includes receiving a query from a user comprising one of the instances; traversing the tree to each node having a same literal ID that corresponds to the instance in the query; and generating a query result based on children nodes of each node traversed to.

According to an exemplary embodiment of the invention, a content management system includes a memory storing a computer program; a database comprising a tree graph, where the tree graph is a tree comprising a plurality of nodes, wherein each node includes a literal identifier (ID) that refers to an instance of one of a plurality of types of data structures and a node ID that uniquely distinguishes the node from the remaining nodes in the tree; and a processor configured to execute the program. The program is configured to present a user interface comprising a selectable tab represented as a first one of the nodes and the selectable tab has a visible item represented as a second one of the nodes descended from the first node.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a system diagram of devices interfacing with a cloud computing platform.

FIG. 2 illustrates a computer server of the cloud computer according to an exemplary embodiment of the invention.

FIG. 3 illustrates software services provided by the computer server according to an exemplary embodiment of the invention.

FIG. 4 illustrates data flows when data is written to and read from the server according to an exemplary embodiment of the invention.

FIG. 5 illustrates an example of a database according to an exemplary to embodiment of the invention.

FIG. 6 illustrates an example of a database according to an exemplary embodiment of the invention.

FIG. 7A illustrates an example of a database according to an exemplary embodiment of the invention.

FIG. 7B illustrates cross nodes of FIG. 7A.

FIG. 7C illustrates cross nodes of FIG. 7A.

FIG. 8 illustrates an example of a database according to an exemplary embodiment of the invention.

FIG. 9 illustrates an example of a database of an embodiment of the invention partitioned across multiple computers in a distributed manner.

FIG. 10 is presented to illustrate the concept of a collection, which may be used in a database according to an exemplary embodiment of the invention.

FIG. 11 is presented to illustrate the concept of an attribute, which may be used in a database according to an exemplary embodiment of the invention.

FIG. 12 illustrates an exemplary interface application based on a database engine according to an exemplary embodiment of the invention.

FIG. 13 illustrates a graphical representation of an example of a database that can be maintained by the database engine.

FIG. 14 illustrates an example of a tags being maintained and linked to items.

FIG. 15 illustrates another exemplary interface application based on the database engine.

### DETAILED DESCRIPTION

It is understood in advance that although this disclosure includes a detailed description on cloud computing, implementations of the teachings recited herein are not limited to a cloud computing environment. Rather, embodiments of the present invention are capable of being implemented in conjunction with any other type of computing environment now known or to be later developed.

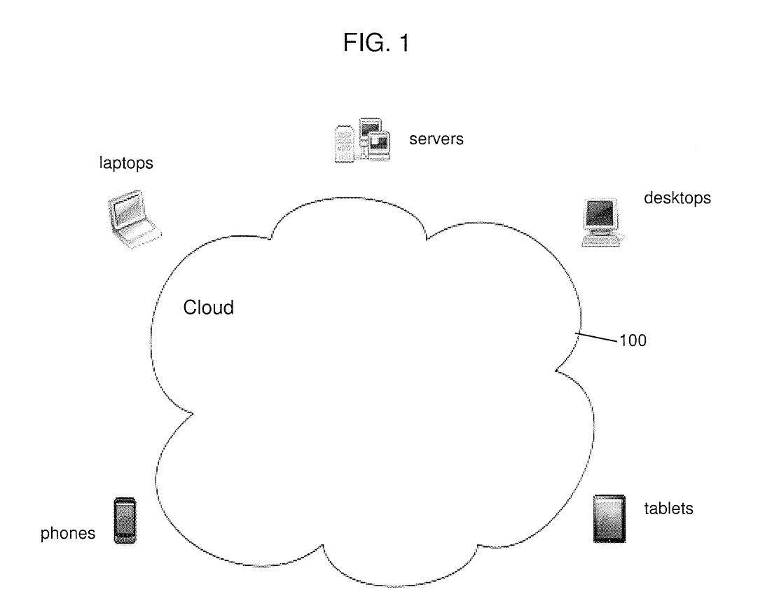

FIG. 1 illustrates a general diagram of a various devices such as laptops, servers, desktop computers, tablet computers, and smart-phones receiving cloud computing services from the cloud 100. Cloud computing provides computation, software, data access, and storage services that do not require end-user knowledge of the physical location and configuration of the system that delivers the services.

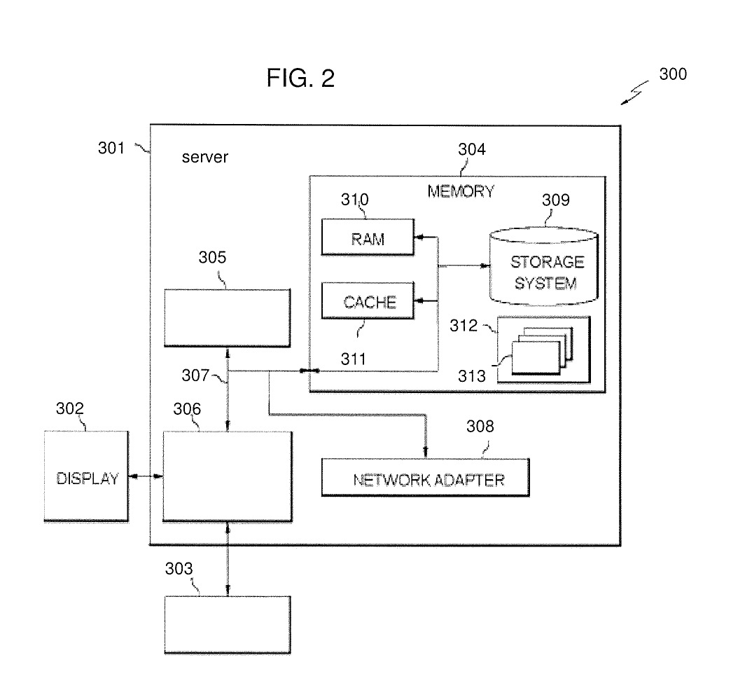

The cloud 100 is supported by a cloud computing infrastructure, which may include a single cloud computing node or a network of interconnected cloud computing nodes. Referring to FIG. 2, a schematic of an example of a cloud computing node is shown. Cloud computing node 300 is only one example of a suitable cloud computing node and is not intended to suggest any limitation as to the scope of use or functionality of embodiments of the invention described herein.

Referring to FIG. 2, the cloud computing node 300 includes a computer server 301, which may operate with numerous other general purpose or special purpose computing system environments or configurations. Examples of well-known computing systems, environments, and/or configurations that may be suitable for use with computer server 301 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments.

The components of computer server 301 may include, but are not limited to, one or more processors or processing units 305, a system memory 304, and a bus 307 that couples various system components including system memory 304 to processor 305. The bus 307 represents one or more of any of several types of bus structures, including a memory bus or memory controller, a peripheral bus, an accelerated graphics port, and a processor or local bus using any of a variety of bus architectures. By way of example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer server 301 may include a variety of computer system readable media. Such media may be any available media that is accessible by computer server 301, and it includes both volatile and non-volatile media, removable and non-removable media. The system memory 304 may include computer system readable media in the form of volatile memory, such as random access memory (RAM) 310 and/or cache memory 311. The computer server 301 may further include other removable/non-removable, volatile/non-volatile computer system storage media. By way of example, storage system 309 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 307 by one or more data media interfaces. The system memory 304 may include at least one program product having a set (e.g., at least one) of program modules that are configured to carry out the functions of embodiments of the invention. The memory 304 may also include a relational database for storing structured data.

A computer program 312, having one or more program modules 313, may be stored in memory 304, as well as an operating system, one or more application programs, other program modules, and program data. Each of the operating system, one or more application programs, other program modules, and program data or some combination thereof, may include an implementation of a networking environment. The program modules 313 may carry out the functions and/or methodologies of embodiments of the invention as described herein.

The computer server 301 may also communicate with one or more external devices 303 such as a keyboard, a pointing device, a display 302, etc.; one or more devices that enable a user to interact with server 301; and/or any devices (e.g., network card, modem, etc.) that enable the computer server 301 to communicate with one or more other computing devices. Such communication can occur via Input/Output (I/O) interfaces 306. The computer server 301 may communicate with one or more networks such as a local area network (LAN), a general wide area network (WAN), and/or a public network (e.g., the Internet) via network adapter 308. As depicted, network adapter 308 communicates with the other components of computer server 301 via bus 307. It should be understood that although not shown, other hardware and/or software components could be used in conjunction with computer server 301. Examples, include, but are not limited to: microcode, device drivers, redundant processing units, external disk drive arrays, RAID systems, tape drives, and data archival storage systems, etc.

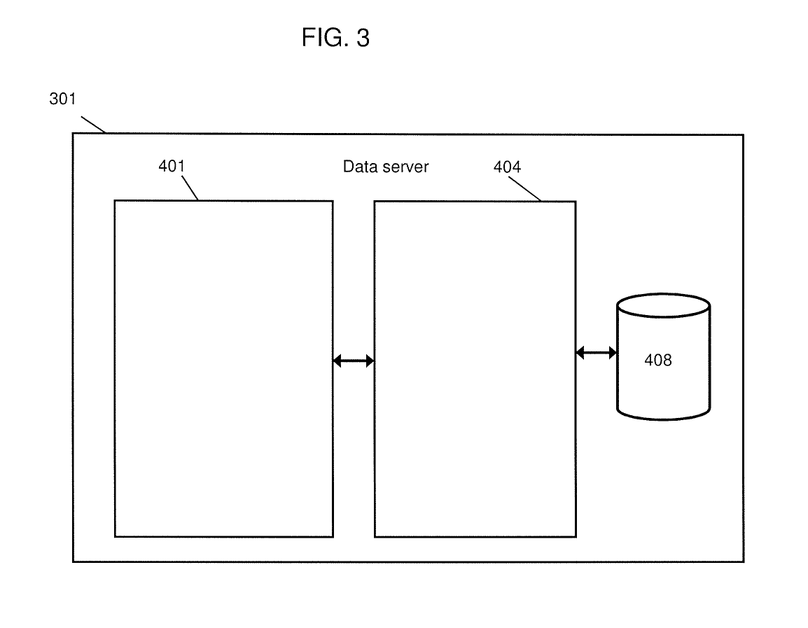

FIG. 3 illustrates software services that may be provided by the computer server 301. The software services may be stored within program 312 or within the program modules 313. The computer server 301 includes a front-end application 401, a back-end application 404, and a database engine 408. The front-end application 401 interfaces with a client application of a remote devices (e.g., a laptop/desktop personal computer, a tablet, etc.), and forwards requests from these devices to the back-end application 404 so data can be written to a database engine 408 or read from the database engine 408.

According to an exemplary embodiment of the invention, the database engine 408 is configured to handle a constantly changing data model where relationships in data do not follow a predefined structure, but can be created dynamically. This design serves to improve querying ability, development speed, and simplify operation for the end user. The database engine 408 deals with data and relationships between data in a very natural and coherent fashion. The database engine 408 is configured as a tree, and the structure of that tree provides context to the data stored within the tree.

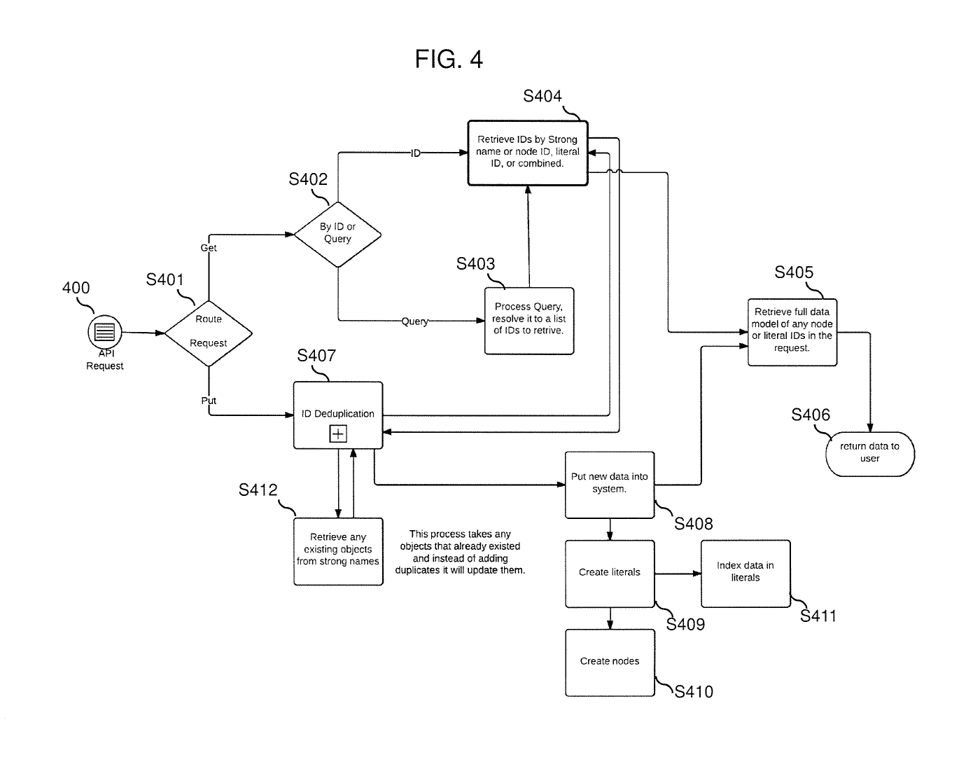

FIG. 4 illustrates data flows for writing data to the database engine 408 and reading data from the database engine 408. In the below example, it is assumed that one of the remote devices illustrated in FIG. 1 is accessing the database engine 408. The client application of the remote device is used by a user of the remote device to make an API request 400 to request that data be written into the database engine 408 (e.g., a Put request) or to request that data be read from or retrieved from the engine 408 (e.g., a Get request). The database engine 408 determines whether the request is a “Get” or a “Put” (S401). If the request is a Get, the database engine 408 determines whether the Get request is by ID or by Query (S402). If the Get request is by Query, the database engine 408 processes the query, which resolves it to a list of IDs (S403), and then retrieves the IDs by Strong name or node ID, literal ID, or combined (S404). If the Get request was instead by ID, the engine 408 proceeds directly to S404. After the IDs have been retrieved, the engine 408 retrieves a full data model of any node or literal IDs in the request (S405) and returns data to the user (S406). If the request is a Put, the engine 408 performs a deduplication operation on an ID in the Put request (S407). The deduplication operation may also be performed on the IDs retrieved by 5404. The new data in the Put request is then stored into the database (S408). This storage includes creating literals (S409), creating nodes based on the literals (S410), and indexing data in the literals (S411). After the deduplication operation has been performed, any existing objects can be retrieved from strong names (S412).

In the database engine 408, distinctions are naturally made between concepts, sub-concepts of those concepts, and sub-concepts of those concepts, et cetera. For instance, “animal” is a high level concept, of which “dog” is sub-concept, of which a specific dog, “Snoopy”, is a specific instance (i.e., a literal of the type, dog. The database engine conforms to a database model that not only distinguishes between a type (e.g., a dog, which inherits from type animal) and a literal of that type (e.g., Snoopy the dog), but also between the related contexts that Snoopy the dog might occur (e.g., Snoopy the dog to is owned by Charlie Brown (CB) who is associated with the Peanuts Comic, Snoopy the dog fights the Red Baron (RB), who is also associated with the Peanuts Comic, etc.). The database model keeps track of information in its most natural form: a literal of a type, references in a specific context (i.e., Snoopy, a literal of the type dog is referenced on the tree as being owned by Charlie Brown).

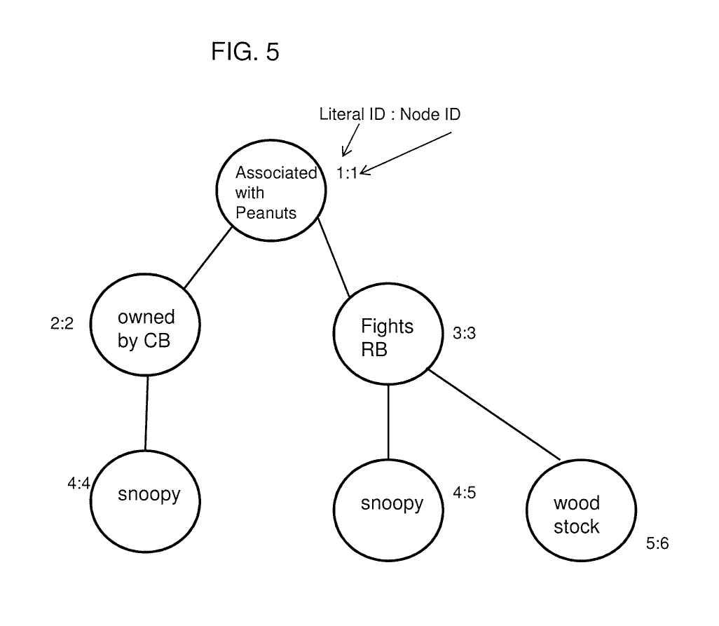

FIG. 5 demonstrates the relationship structure from the above-described Snoopy example, where each node includes a literal identifier (LI) and a node identifier (NI) (LI:NI). In an exemplary embodiment, the node:literal relationships are stored in fixed length fields. As shown in FIG. 5, a first node (NI=1) of the tree having a LI=1 indicates that all data below the first node is associated with the Peanuts Comic. Thus, whenever a Peanuts Comic related query is made, performing the query involves traversing initially to the first node. The first node (NI=1) has a second node (NI=2) and a third node (NI=3), as its children. The second node (NI=2) has a LI=2 that indicates all data below it is owned by Charlie Brown. The third node (NI=3) has a LI=3 that indicates all data below it fights the Red Baron. Since the fourth node (NI=4) is below the second node, it is owned by Charlie Brown and its literal ID of 4 indicates it is Snoopy. Since the fifth node (NI=5) is below the third node, it fights the Red Baron and its same LITERAL ID of 4 indicates that it is also Snoopy. Since the sixth node (NI=6) is below the third node, it fights the Red Baron and its LITERAL ID of 5 indicates it is Woodstock.

The database model according to an embodiment of the invention comprises types, literals (instances) of types, and nodes referring to literals of types (i.e., the data) that are placed on a tree. The types are entirely customizable abstractions that determine the properties the literals will inherit. For example, a person type might be endowed with a name, phone number, email address, etc. Literals are of a specific type and encapsulate a concrete implementation that represents a data element (e.g., Snoopy the dog). Nodes of the tree referring to literals provide the encapsulated elements with contexts on the hierarchical tree. For example, the position of the nodes in the tree with the same literal ID representing Snoopy relative to the other nodes provide context information about Snoopy (i.e., that Snoopy is both owned by Charlie Brown and fights the Red Baron). As a result of this structure, the database model according to an embodiment of the invention provides an elegant means for performing set theory operations. A simple query could refer to the fields of a literal. For example, a query for a red hat could look like “select hat.color=red”, where hat is the type and color is field of the type. A set query to return red hats over 100 pounds or greed hats could look like “select hat.color=red AND hat.weight>100) or (hat.color=green), weight is another field of the same type.

The database model according an embodiment of the invention is a low level data architecture comprises of customizable types, literals (instances) of those types, and nodes referring to the literals of the types located in a structural hierarchy or tree. Types are differentiated by their functional properties. For example, type person may have name an email while type dog may have name and rabies shot date. For each object stored in the database, a literal is created of a specific type, each of which is given a unique literal ID. For example, Lassie of type dog would have a different literal ID (e.g., 7) as compared to Snoopy of type dog, which has an literal ID of 4. Nodes referring to a literal are in specific location on a hierarchical tree and have a unique NI in addition to their literal ID. The location can be an absolute location or relative location that is relative to other nodes within the tree. By this format, relationships between literals are expressed through the structure of the nodes in the tree.

The different types are differentiated by the different properties they contain. Types are entirely customizable by the user. For example, a client program on a remote device is launched by a user, which connects to the database, and the client program provides a user interface to the user that enables the user to create a new type. Types may obey an inheritance structure, analogous to the relationship between classes in standard object oriented programming. This is provided as a convenience to easily delineate the different types of data to be stored. An inheritance structure implies the existence of an intrinsic base object. For example, a user creating a new type could begin by using the interface to select an existing base object to inherit base properties from. Then, the user can use the interface to create additional properties for the type that differ from the base properties. For example, a base object could have a single “name” property, and a custom type could be created with a property that overrides the “name” field. Types merely act as a template for literals, and alone, do not store any data.

Literals are created from types and represent concrete objects. As an example, to store a particular person in the database, one could create a literal of the type person. This person would be provided with a “name” from the base property and the other properties specified by the “person” type. However, a literal alone does not constitute any actual “data” from the perspective of the database. Technically literals do contain information, such as the contact information property of a literal of type person, but from the perspective of the database model, the “data” only exists in the tree that references the literals. Even after several literals of type person are created (e.g., John, Mary, Ted, etc.), since they are not initially in a tree, they have no context (i.e., they have relationship to other literals).

Nodes create the hierarchical tree and are considered the “data” stored in the database. Each node refers to a specific literal, in effect, providing for the relationships among the various literals. Other than the root node, each node has a parent node and a child collection. A child collection is a list of nodes that fall under the parent node. The root node has no parent, and when a node is a leaf node, its child collection is empty. For example, in FIG. 5, the node with an NI:3 and LI:3 has a parent with NI:1 and LI:1 and a child collection of 2 nodes.

Each node has a unique node ID but its literal ID need not be unique. The literal ID refers to a literal, which is an instance of a type. Relationships are created by adding nodes to the tree, dynamically creating a structure relevant to the purpose of the database. This database model design enables one to perform set theory operations in an elegant manner. To compute an intercept, one merely needs to compare each literal ID of the nodes to determine matches. For example, if a user wants information about Snoopy, the system determines that Snoopy has a literal ID of 4, and then searches the tree for each matching node that has the literal ID of 4, which would return node IDs of 4 and 5. A node ID may also be referred to as a node ID address. Each node can have a strong name in lieu of their node ID address so that a node can be retrieved directly via programming. A strong name is a unique name for the database and is represented by a string. A strong name may be chosen by the application developer.

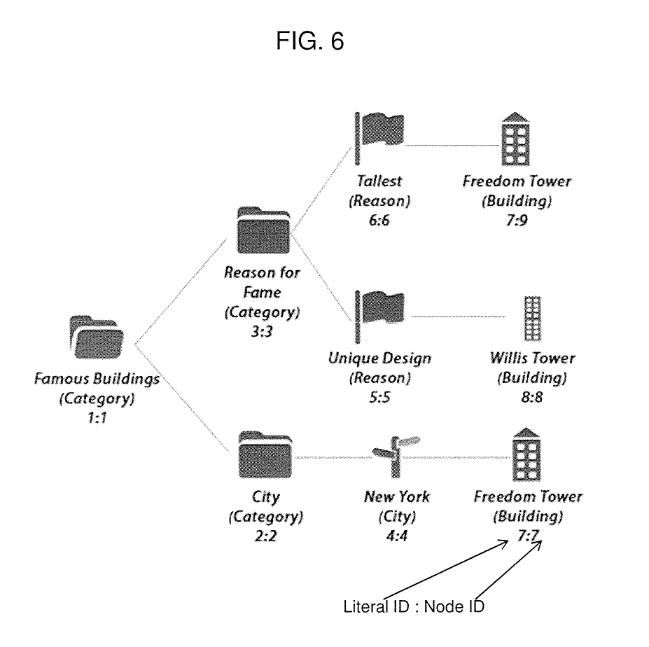

FIG. 6 illustrates another example of a tree within a database according to an exemplary embodiment of the invention. The tree is made up of literals of type category, reason, city, and building. The first node (NI=1) has a literal ID of 1 that corresponds to literal famous buildings of type category. The first node has a second node (NI=2) and a third node (NI=3), as children. The literal ID of 2 of the second node (NI=2) corresponds to city literal of type category. The literal ID of 3 of the third node (NI=3) corresponds to a reason for frame literal of type category. The second node (NI=2) has a fourth node (NI=4) as a child, whose literal ID of 4 corresponds to a New York literal of type City. The third node (NI=3) has a fifth node (NI=6) as a child whose literal ID of 5 corresponds to a unique design literal of type reason, and a sixth node (NI=6) as a child whose literal ID of 6 corresponds to a tallest literal of type reason. The fourth node (NI=4) has a seventh node (NI=7) as child whose literal ID of 7 corresponds to a Freedom Tower literal of type building, the fifth node (NI=5) has an eighth node (NI=8) whose literal ID of 8 corresponds to a Willis Tower of type building, and the sixth node (NI=6) whose literal ID of 7 also corresponds to the same Freedom Tower literal. From the positions of the nodes having the same literal ID of 7 within the tree, a great deal of information about the Freedom Tower can be discerned. For example, since it is below the first, fourth, and sixth nodes, it is a famous building, it is tallest, and it is located in New York City.

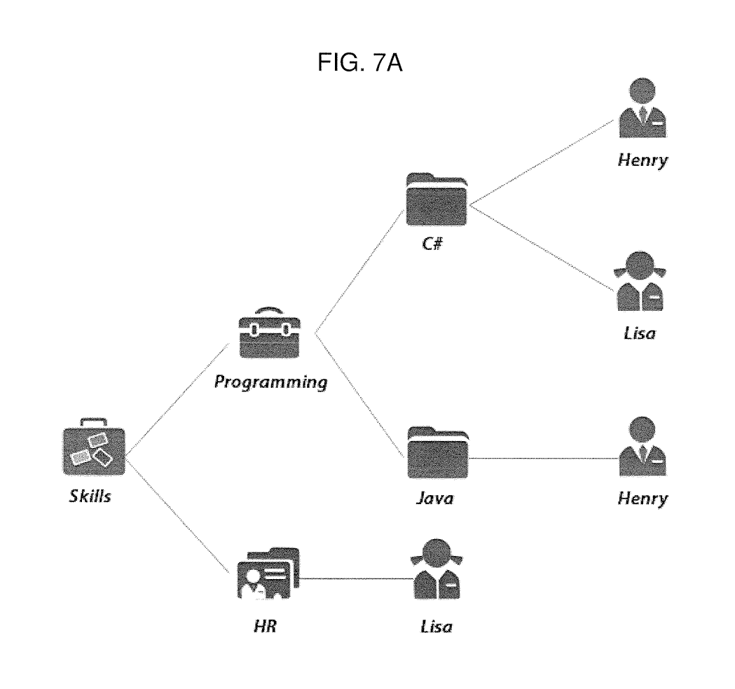

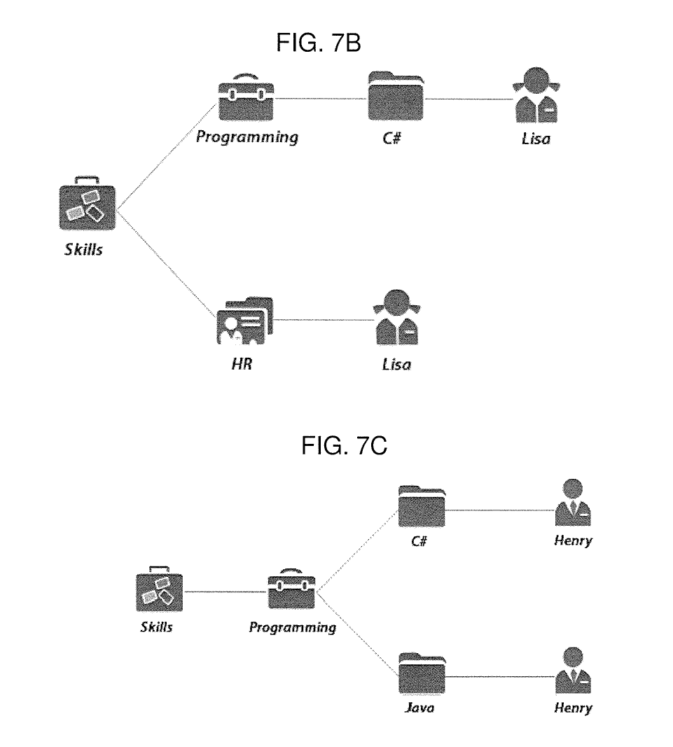

All the nodes that refer to a given literal (i.e., refer to the same literal ID) are referred to as cross nodes. When considering a specific node, its cross nodes show you all the other locations of this data object, the literal, within the database. Thus, the user is privy to all the other contexts in which the object exists and can see all its relationships with other data in the system. FIGS. 7A, 7B, and 7C provide illustrations that are used to describe cross nodes. FIG. 7A shows a database that lists employees and their skills. The database is structured as a hierarchy of skills. Each employee is then made a member of a given skill. For example, employee Henry is a member of programming skill of C# and JAVA and employee Lisa is a member of programming skill C#. While the whole database illustrated in FIG. 7A shows all the employees and all their skills, the cross nodes for a given employee just show that employee's skills. For example, FIG. 7B illustrates only the cross nodes of employee Lisa and FIG. 7C illustrates only the cross nodes of employee Henry. FIG. 7B is identical to FIG. 7A, but with Henry pruned out. FIG. 7C is identical to FIG. 7A, but with Lisa pruned out. In a larger database, with more nodes, the entire hierarchy would involved many literals (i.e., data objects) and the utility of this reduction becomes more apparent. When this pruning is implemented, it provides a natural way to view all the interrelationships of a given data object.

Data in a database according to an exemplary embodiment of the invention may be retrieved (i.e., queried). A query of the database returns a Map with the literal ID as the key and a node ID as its value. The Map is a data structure that maps (in the mathematical sense) a key to a value in a one to one fashion. The Map contains the set of all keys. For example, in the skills database illustrated in FIG. 7A, one query would be to find employees skilled in both “java” and “C#”. Rephrased, the query asks: “are there any nodes under both “java” and “C#” that have the same LITERAL ID (i.e., that are the same literal)?”. Referring to FIG. 7A or 7C, the answer to the query is “Henry”. Since the structure of the database naturally provides all the children of any node, a query is naturally implemented by comparing literal IDs.

The database shown in FIG. 7A may be composed of literals of type skill and literals of type employee. In the below example, assume the literal ID of the node labeled Henry below the Java node is 1, the literal ID of the node labeled Henry below the C# node is also 1, and the literal ID of the node labeled Lisa below the C# node is 2.

As an example, a query to retrieve all employees skilled in “java” and Cr could be formatted as HAVING literal & literal, or more particularly HAVING “java” and “C#”. A computer program interpreting the formatted statement could traverse the tree until it finds a node having a java literal to collect all the literal IDs of its children (1), traverse the tree until it finds a node having a C# literal to collect all the literal IDs of its children (1,2), and then the intersection of the results ((1) and (1,2) returns a literal ID of 1, which corresponds to Henry.

As an example, a query to retrieve all employees skilled in “HR” and Cr could be formatted as HAVING literal & literal, or more particularly HAVING “HR” and “C#”. A computer program interpreting the formatted statement could traverse the tree until it finds a node having a “HR” literal to collect all the literal IDs of its children (2), traverse the tree until it finds a node having a C# literal to collect all the literal IDs of its children (1,2), and then the intersection of the results ((2) and (1,2) returns a literal ID of 2, which corresponds to Lisa.

Queries allow the user to ask complicated questions, stringing together multiple searches. Depending on the implementation, significantly more advanced queries are possible. For instance, one could implement an index for keyword searching, or an algorithm for determining “within distance x of an object”. Any of these searches will return sets of literal ID's. Since the literal ID is constant across the sets (i.e. within all data in the database) for a given literal, a query (i.e. determining membership in all the sets) is simply matching literal ID's across the sets.

The database model use of hierarchies and sets enables certain operations on data to be computed naturally and with high efficiency. Any operation (e.g. summation) on the data can be computed in constant time, as long as the database hierarchy is appropriately configured.

For example, consider a database of people invited to an event. In a relational model, one would create a column for each invitee and a column for the number of guests that invitee is bringing. To find the total number of guests, one needs to traverse each entry and sum. The efficiency of this algorithm is linearly proportional to the number of invitees (i.e. the complexity is O(N), where N is the number of invitees).

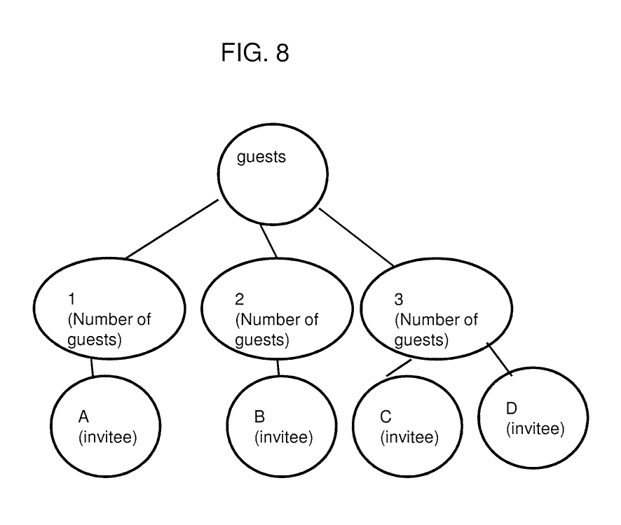

In a database model according to an exemplary embodiment of the invention, one can drastically reduce the complexity of this operation. As shown in FIG. 8, one would create a tree with “guests” as the root, and then a different number of guests as the children. Then, each invitee would be a child of the appropriate “number of guests” node representing the number of guests that invitee is bringing. To find the total number of guests, one only needs to add up the following: the number of members in each “number of guests” node multiplied with that number (i.e. if 6 people are bringing 4 guests each, then that node contributes 24 guests). The efficiency of this algorithm is linearly proportional to the number of “number of guests” nodes (i.e. the complexity is O(M), where M is the number of “number of guests” nodes). M is only equal to N (the total number of invitees) if each invitee is bringing a different number of guests. Usually, M is much less than N.

If, for instance, we know in advance that each invitee can only bring a certain number of guests (i.e. only one or two or three) then this operation is constant time in the number of invitees, i.e. O(1). This feature is predicated on using the structure of the database to essentially store this information while the data is entered, obviating the need to traverse the database.

Partitions are a prescription for splitting up a database among multiple physical devices. Partitioning can be performed when the database is to be implemented on the “cloud” rather than on one physical server. In a partitioning scheme according to an exemplary embodiment of the invention, each node is the root of a subtree that can act as the place of partitioning. For instance, in FIG. 6A, a possible partitioning scheme of this database would be for the “Skills” tree to reside on one server and “Java” and “C#” subtrees to reside on others.

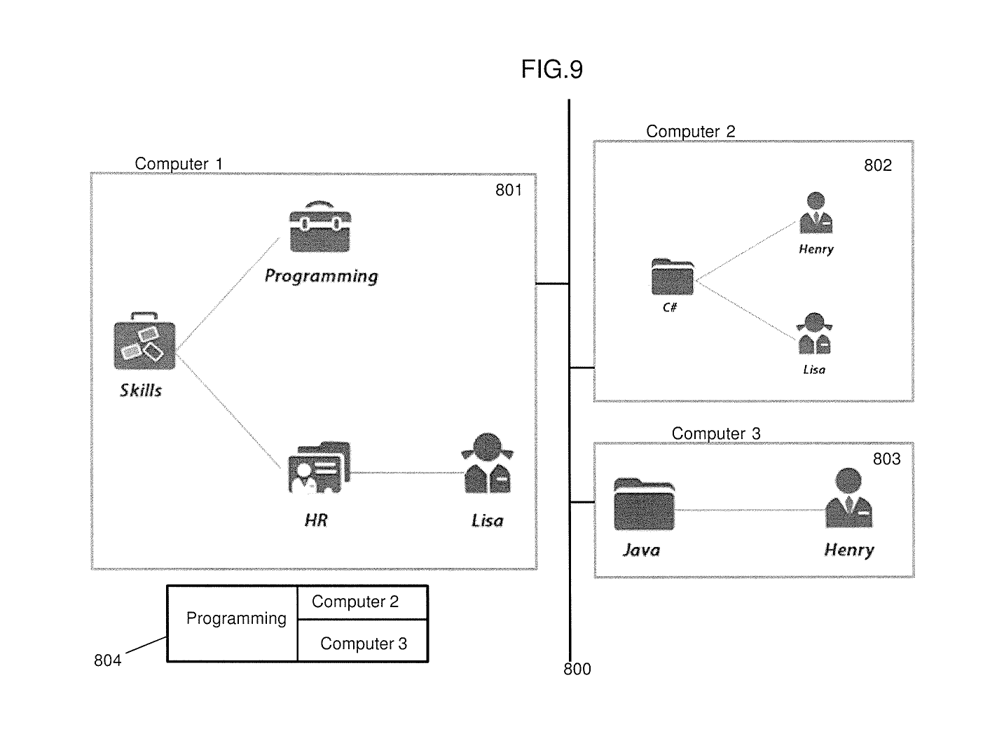

An example of this partitioning is illustrated in FIG. 7, which shows a first computer 801, a second computer 802, and a third computer 803 configured to communicate with one another across a network 800 (e.g., the Internet). The first computer 801 stores a first part of the database corresponding to the “skill” tree, the second computer 802 stores a second part of the database corresponding to the “C#” subtree, and the third computer 803 stores a third part of the database corresponding to the “Java” subtree. For example, a partition table 804 may be stored on the first computer 801 so that it can link its main tree to the subtrees. The partition table 804 may include an entry for a connecting node of the tree that identifies the computer housing a children section that is to be a child of the node. For example, the partition table 804 of FIG. 9 includes an entry for the programming node that identifies that the first and second computers 802 and 803 house subtrees that are to be connected to the programming node. The entries may include the Internet Protocol (IP) addresses of the computers housing the subtrees.

According to an exemplary embodiment of the invention, an Application is provided to make accessing and querying the data within the database more natural for an end user. The Application is optimized for use by both professional database programmers and average non-technical users. The application surpasses the ease and simplicity of a spreadsheet for simple data storage and is more powerful than a full relational database. The Application extends the database model to include Types, Collections, Attributes, and Widgets, which are denoted as Schema. Additionally, the Application contains two ways of “browsing” the same data, the data tree and the query tree. A query tree is a set of queries (i.e., many queries connected together). Functionally, the data contains the “data” and allows one to browse through the information in the database, and the query implements specialized searching.

In an exemplary implementation of the Application, Types are the direct representation of their counterpart types in the database model. A Type is determined by its properties, which are set and customized by the user. A generic Type is endowed with one property, “name,” and a settable icon. Types can also inherit from one or many other Types, in which case they will be endowed with the properties of those they inherit from. These properties can be individually overwritten as desired. For example, a “name” property could be overwritten “nombre”. This bares strong resemblance to the philosophy of object oriented programming and abstractly is meant to operate in much the same way.

Otherwise, Types again function as templates for literals. The Type “employee” may inherit from “person.” “Person” may contain the properties “name” and “email address” and other basic contact information, while “employee” may include properties like “Title,” “Year Hired,” et cetera. One can then instantiate a specific employee, “Henry”, and reference him on the tree (i.e. create the literal “Henry” and create his nodes on the tree). This works exactly as discussed above with respect to the database model, supplemented with the additional structure provided by Collections and Attributes as will be discussed below.

Collections exist to mitigate the following problem: A sports team is always equipped with players. We would like both the “sports team” and the “players” to exist in our database. Also, as a “sports team” always has “players” we would like the players always to be referenced under the sports team in all locations that the sports team is referenced in the database (i.e. all locations it exists on the tree). The “players” should exist as a subtree for all nodes of the “sports team”. Without the additional structure of Collections, we would have two options: (1) create a Type player and instantiate all the team's players or (2) create players as properties associated with the Type sports team. The first option is fine as long as the sports team is only referenced a single time. As soon as the sports team's node is copied in a second location, one would have to individually ropy all the players to that location as well. A ropy refers to a reference copy. The distinction is made to emphasize that the reference (or node) is copied, but both nodes still refer to the same instantiated literal. A generic literal of a type in the database model does not have its children since the children only have to do with the structure of nodes in the tree and not the underlying literal, and copying the node (roping) does not ropy the children. While the second option (creating the players as properties) does endow each node with its players, in this case the players are not “data” in their own right, but just properties of the Type “sports team”.

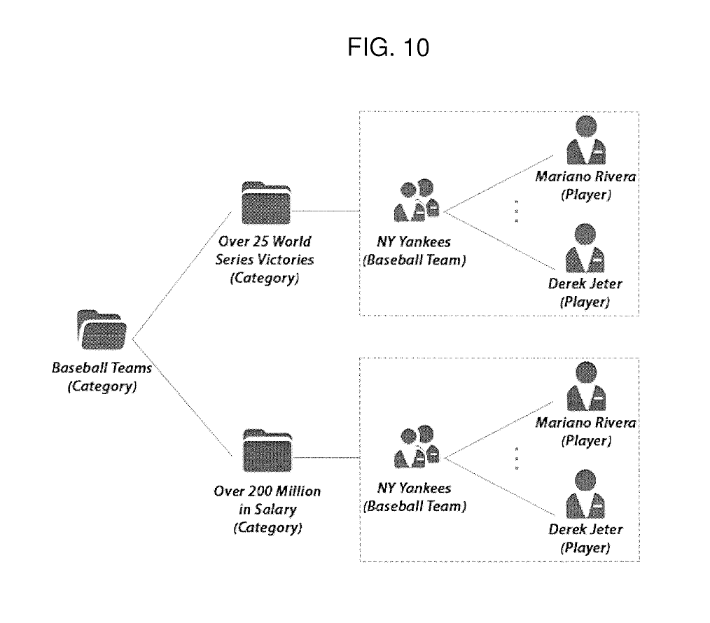

A Collection allows a literal of a Type to always have specified nodes under it. Thus, a Collection can be thought of things that a literal of a Type always “has”. As in the previous example, a “sports team” can always have “players.” Abstractly, this means that the node (e.g. “a sports team”) will always exist as a subtree with that node (“the sports team”) as the root, and the objects in its collection as the children. A ropy of the node will automatically include the Collection under it. Collections can be associated with any number of Types, and one Types can “have” multiple Collections associated to it. In summary, Collections expand the abstract idea of nodes (to a specific literal) to be a subtree rather than a single node. This construction is demonstrated in FIG. 10. For example, the node labeled “NY Yankees” is an example of a Collection.

Attributes are a special type of property and are used to enable a special type of querying. Attributes are stored as a tree. Nodes which declare themselves as having an attribute are then instantiated underneath the attribute tree. The tree is assembled and delivered by examining the cross references. As an example, node a will be references under attribute a b c, where a can be b's parent. Various “skills” that a person may have can be organized in a tree structure—with “skills” at the root and generic subskills, such as “music” or “programming or “teaching”, at the next level, and specifics like “java” (or more particularly a level of expertise out of 10 at Java programming) and “C#” or “Guitar” and “Piano” at the final level. Endowing a specific Type with all these skills as properties would be not only cumbersome, but also unnatural.

Instead, the “skills” tree is created using Attributes. First, the Root Attributes, “skills” is created, and then a tree is built beneath it. Root Attributes can be associated with Types, just as Collections can be associated with Types. Again, this is the abstract statement that a Type “has” that set of Attributes (i.e. an “employee” has a set of “skills”).

Unlike Collections, Attributes are not expressed as children nodes (i.e. subtrees). Instead, Attributes build out an entirely separate tree. Separate from our main data tree is the query tree. Under the query tree are all the Root Attributes (such as “skills”), and underneath it is the entire “skills” subtree (i.e. “music” and “programming” and “teaching”). When a Root Attribute is associated to a Type and an instance is created and Attributes are filled out, that literal is referenced at the bottom of the query tree under all its Attributes. Thus, browsing the query tree is a way of browsing through Attributes that given objects have.

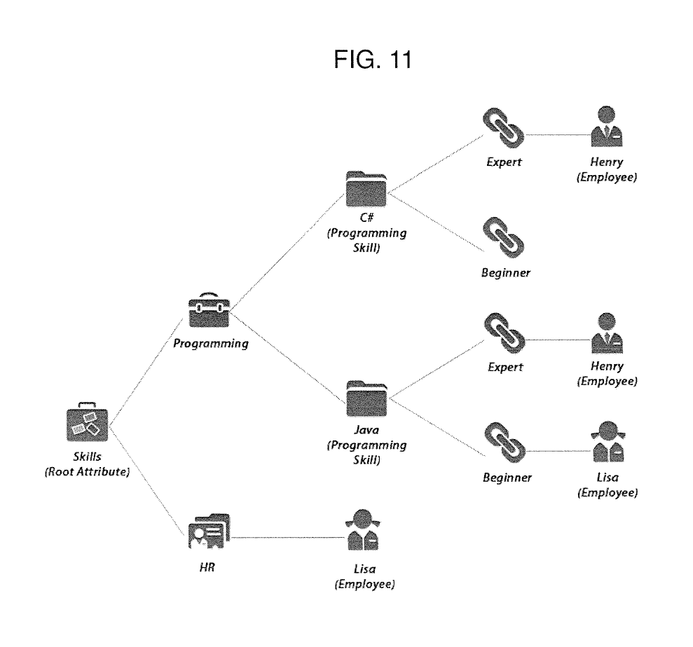

As an added feature, Attribute Types are provided, which is a “typing” for Attributes. Let's assume that under all programming skills (like “Java”, “PHP”, “C#”, “MATLAB”, etc.) we want to keep track of sub-attributes (like “Years Used” and “Skill Level” and “Total Lines Coded”, et cetera). Rather than building such a subtree under each “programming skill”, we can instead create an Attribute Type “programming skill” and specify that our programming skills (“Java” and “PHP” . . . ) are, in fact, “programming skills”. This will automatically create the subtree under those Attributes. An example of the use of Attributes and Attribute Types is shown in FIG. 11.

Scripts are used to let the end user control how a node is displayed in the Application. Thus, one can create a Script to allow a node of type YouTube video to display the actual video as opposed to a standard data-view (or have a “doc” or “spreadsheet” or “presentation display” in their most natural forms). In an exemplar embodiment, scripts are javascript based. They take a node and transform it using the API and then present it to the user. So if one wants to take a text record “Robert” and make the text appear bold, the application can run it through a javascript function which would return the HTML of <b>Robert <b>. The script can also be represented with a function format (e.g., function format(data) {return bind(<b>{{data.name}1<b>, data};}.

Widgets allow for the user to extend a Type by writing custom code. Widgets, like Collections and Attributes, can be associated with a Type. In the previous video example, this is one way of specifying that a Type video is actually a video and should be treated as such. An example of a Widget is a comment widget. For example, any record that allows for comments can have a comment widget attached to the type.

A special Type, “user”, exists (e.g., a user of the Application). Users are invited to access a database as collaborators by the database creator (who is also a user). Every action of a user is logged. Furthermore, a special type of user is generated for external systems that access the database (i.e. for accessing via an API).

The node structure of the Application and the database model allow for easy implementation of security between databases and sub-databases. Administrators can then assign users access to only certain nodes. Users under this “isolation” can view their assigned nodes and sub-nodes, but nothing else. When viewing cross nodes, the isolated users will only see cross nodes that exist under their allowed nodes. For instance, a database for a company might be organized by office. Users of the database can then be assigned access to only the subtree of their physical office. This would prevent them from viewing data from other offices, even though the data all exists in the same database.

The node structure of the Application and the database model allow for easy implementation of security between databases and sub-databases. Administrators can then assign users access to only certain nodes. Users under this “isolation” can view their assigned nodes and sub-nodes, but nothing else. When viewing cross nodes, the isolated users will only see cross nodes that exist under their allowed nodes. For instance, a database for a company might be organized by office. Users of the database can then be assigned access to only the subtree of their physical office. This would prevent them from viewing data from other offices, even though the data all exists in the same database.

The Application implements the database model but is endowed with additional structure to enable higher level functionality. Collections allow nodes to always “have” other nodes, much in the way that they always “have” properties. They transform a single node into a subtree. Attributes are essentially super-properties that enable advanced search functionality. They create a separate query tree that can be both browsed and pruned (via set theory operations). Widgets and Scripts let the user alter the way the Application displays and interprets the “data”, essentially telling the database that not all data is the same and certain data (i.e. videos) are different and should be treated as such.

In an exemplary embodiment, the Application runs on top of a GOOGLE Application Engine. In a database according to an exemplary embodiment of the invention, all data ((i.e. even Collections and Attributes) is contained in a single tree.

A system using the Application according to an embodiment of the invention to interface with a database according to an embodiment of the invention can be used as a cloud-based Enterprise Content Management system.

The Application can be used to organize/sort GOOGLE DRIVE documents, MICROSOFT based documents, Videos, Images, ADOBE based documents, music, any other filed type or data point, and then assign Metadata (structured, keyword and location) and Tasks to those files and data points.

The application enables users to search across the entire portal (e.g., a website) and provides advanced filters that allow for refined results based on tagged Metadata. The application allows users to store data and documents as they pertain to a person, place or thing in one unified view. The application can also search across YOUTUBE and pull videos directly into its portal, as well as store links to websites that can function as live websites inside the portal.

The application can pull any and all documents loaded into GOOGLE DRIVE into the Portal and allow users to work with them directly in the portal including: Sorting/Organizing the documents into Tabs/Categories/Folders/Object Collections, editing the documents directly in the portal using GOOGLE's standard features, assigning Tasks to the documents and adding MetaData to the documents. Anything that a user has available to them in GOOGLE Drive is retained in Application's Portal including: live collaboration, autosave, all editing tools, and granular permissioning. In addition to DRIVE's standard features, users of the Application have the option to Lock a DRIVE document to prevent others from working on it at the same time. Users are also able to create new GOOGLE DRIVE documents from within the portal, giving them the exact same capabilities to work with the document. New GOOGLE DRIVE documents originated in the Portal will also appear in the creator's GOOGLE DRIVE.

Users can also Link existing DRIVE folders into the Portal, allowing for an entire DRIVE folder to be managed and edited. All changes to documents, whether made in the Portal or in GOOGLE DRIVE are synced automatically in real time for every user in the Portal and in DRIVE, including those DRIVE documents that originated in the Application using its create new Drive document feature.

Users are also allowed to drag and drop MICROSOFT based files such as MICROSOFT WORD, POWERPOINT, and EXCEL into the Portal or pull existing MICROSOFT based files from their GOOGLE DRIVE. The Application then allows users to work with them by: sorting/organizing the documents into Tabs/Categories/Folders/Object Collections, assigning Tasks to the documents and adding MetaData to the documents, and use Check in/Check with Versioning to control who can work on the document at any given time.

Any other type of file can be added into the system using drag and drop, selecting files from your local computer or pulling them from your existing items in GOOGLE DRIVE. Other File Types such as PDF's, Videos, Images and more can also be organized into Tabs/Categories/Folders/Object Collections, as well as, have metadata tagged and tasks assigned to them.

The Application allows users to create generic Objects (e.g., literals). An Object can be a person, place or thing. Users then define fields for information or data that they want to gather that pertains to said Object, such as “phone number, email address, title, etc.” Users can also define collections, or sub-folders to be associated with each Object to gather and store files and documents that pertain to said Object. Once a type of Object is created and fields and collections are defined, users can select the Object from a user interface of the Application, name it, fill out the fields and add files or documents of any type including DRIVE and MICROSOFT based files to the Object's collections, or sub-folders. For example, users can create a “Staff Object” which is the generic Object for others to use. When other users add a new “Staff Object” they will name it with the staff person's name and fill out the appropriate information that pertains to that individual staff member. Users can add the generic Object as many times as they want, naming it with an individual staff member's name thus creating new instances of that generic “Staff Object”. The Objects are different instances of the generic “Staff Object” and naming one “Staff Object” George then naming another “Staff Object” Steve does not change George's Object's name. They are completely independent of each other although they originate from the generic “Staff Object”.

Objects are useful when trying to organize a person, place or thing's data and documents/files in one place, they can also be used to manage relationships. For example a “Staff Object” might have a collection called Locations, in that collection a “Location Object”, specifying an exact location, can be stored, thus allowing others to see that this staff member is associated with that particular location.

At the highest level of organization are broad-concept Tabs that run across the top of the Application home screen. Tabs provide an organized view into your stored and shared documents and data.

To allow for maximum structure around content, the Application gives users the ability to create categories, folders and objects within each tab. Under categories users can add content directly or create Folders to store content within.

Objects can be created to collect and unify data and documents as they pertain to people, places or things. Users can create custom fields to contain data as well as custom collections, or sub categories to contain documents. Fields and collections can be modified at any time. Users can associate Objects with one another allowing for complex relationship management.

Access can be granted at the Tab level, allowing users to view all content within. Users can also choose to use the Application's granular permissions, which allows for access to be set on each Item, such as folder, document or object. From the Permissions Page, users can set either “Read access”, or “view only access”, or “Write access” which allows others to modify the contents of a Tab or Item. This may be done by inputting a user's email address, group affiliation or a domain name then selecting the corresponding permission from the drop down menu. Users will receive an email notification inviting them to the tab or document to which they've been added.

The application gives users the ability to create GOOGLE DOCS directly within the portal by selecting a document type from a main prompt menu OR selecting an existing item to upload an existing Doc from their DRIVE.

Users are then able to work with these documents, retaining DRIVE's ability to autosave and collaborate live, without opening additional tabs or windows by clicking the Edit button. For change sensitive documents, users can choose to lock a Google Document preventing others from working on it at the same time.

The Application provides check-in/checkout functionality. The application's Checkout feature enables the user to take possession of a File, thereby restricting access to other Users. In an exemplary embodiment, the application presents a user interface with a Checkout button that only appears when any Non-Drive File in the portal, such as a WORD or a POWERPOINT document is opened. Clicking this button will download the file. The file will display a “Checked out by” message, providing identifying information about the file holder (e.g., his email address, name, etc.) until it is checked back in. The user can request access to the file by clicking on the identifying information. When the file is checked back in, the application automatically creates a revision history, with all previous versions available for download.

The application provides a search function that enables users to run a search across all content on YouTube's website and add videos directly into the portal, providing others access. With only knowledge of the URL, a live website link can be added to the Application that can be browsed directly through the portal by all users. The links feature works like a browser bookmark allowing users to direct others to important information on the web.

The application has a Reference Copy feature that allows items to appear in several different locations while maintaining a single instance of that document, with all changes saved in real time across the portal.

The application provides a user interface (portal dashboard) so that users can create tasks and associate them with any file or document type. The application gives users the ability to save notes or comments with each task, assign tasks to other users, update task status, sync with GOOGLE CALENDAR, and accept or reject the task. For example, under record a collection called notes is attached and the notes are stored as children of the collection. The Tasks column of the interface will keep an up-to-date list of all assigned tasks.

The Application provides three types of tagging to help add additional data to documents and files which can then be utilized when filtering search results. In the simplest form of tagging, keyword tags, can be comprised of any free form text.

The Application has a search function where keyword tags are treated as any other text content and search results can be filtered by tagged content in the search filter panel. The application provides location tagging that allows a user to associate any place of interest, or address, and map it by geographical coordinates.

Search results are displayed with a GOOGLE map view, which allows for filtering by location. Structured tags can also be enabled for company wide use and compliancy. Predetermined hierarchy in structured tags prompts users to tag content in a uniform way by guiding users through the selection process, disabling certain categories from being the final tag and enabling a multiple selection process when necessary.

For example, a human resource manager screening candidates would be prompted to tag a candidate's overall qualifications, by choosing in range from “Exceeds qualifications” to “Does not meet qualifications” with screeners only being allowed to select one tag. In a case where we would like to associate skills with those candidates, screeners would be prompted to select as many skills that apply by selecting multiple tags.

For each Portal, users can search through their GOOGLE Contacts and add them as a new Object to manage that contact's data, documents and conversation trail. Once a contact is added into the Portal, users can view all conversations and messages between themselves and that contact. They are then able to “pin” or save any conversation threads or individual messages to that contact. The data fields for each contact will be automatically populated by extracting data from emails such as contact info, but will still be editable to the user.

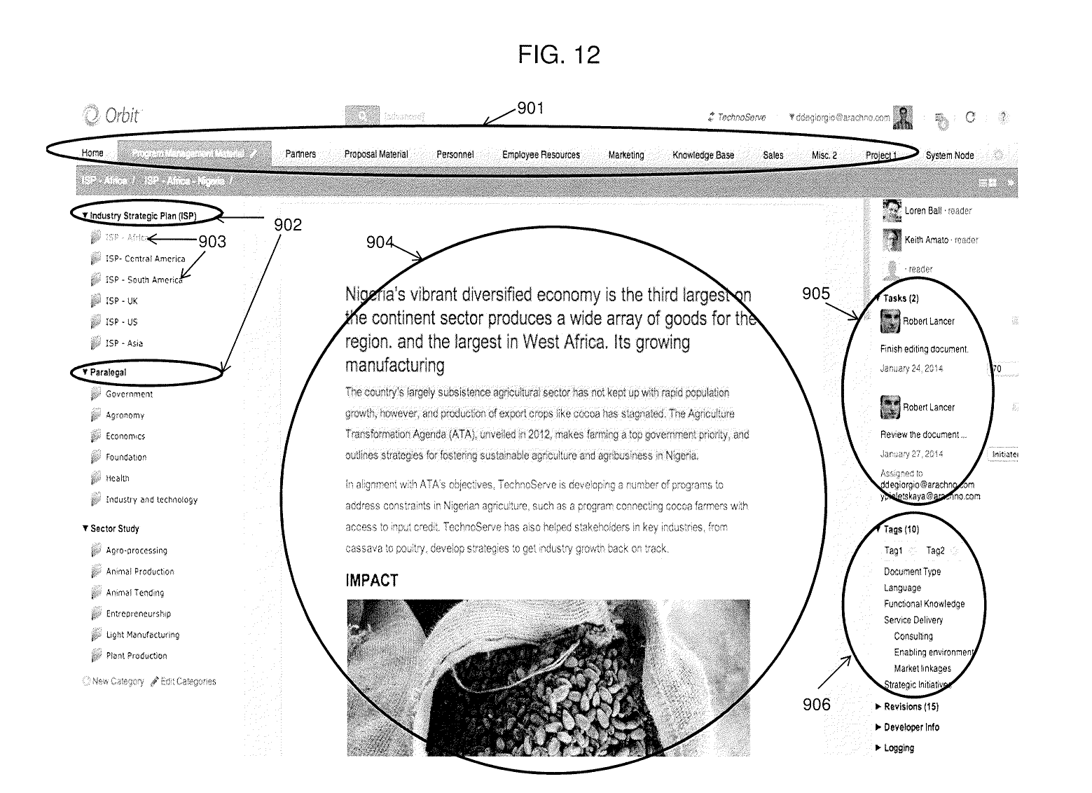

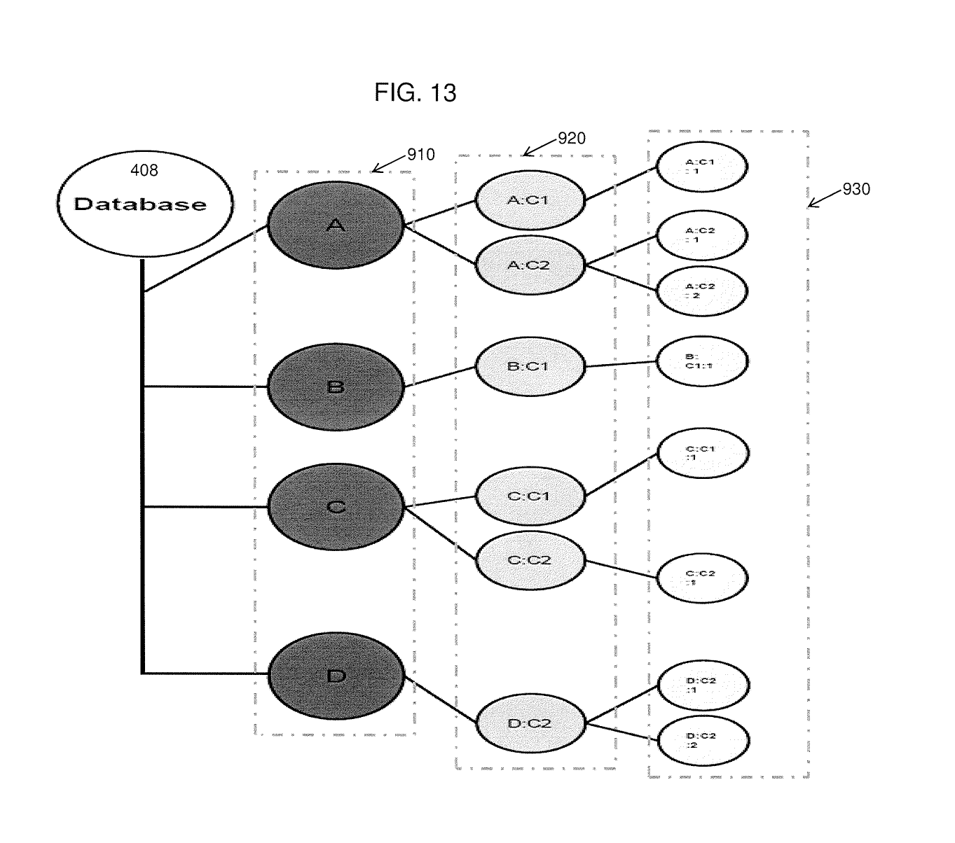

FIG. 12 illustrates an exemplary user interface application that makes use of elements managed by the database engine 408. FIG. 12 will be discussed with respect to FIG. 13, which illustrates how the elements of the user interface are organized within the database engine 408. The interface includes several selectable tabs 901, where the “Program Management Material” tag is currently selected, and other tags such as “Partners”, “Proposal Material”, “Personnel”, etc., can be selected next. The nodes 910 shown in FIG. 13 may represent the tags 901. For example, the node labeled “A” among nodes 910 could correspond to the tag labeled “Program Management Material” among the tabs 901. The tabs 901 are the application's highest level of groupings. In an exemplary embodiment, permissions can be set here or more granularly at the folder or document level. The tabs 901 can be customized by the user. The application may also provide public facing views at the tab level.

The interface includes several categories 902 within the selected tab. For example, since the “Program Management Material” tab is currently selected, the interface displays its categories 903, such as “ISP”, “Paralegal”, etc. The nodes 920 shown in FIG. 13 may represent categories 903. For example, the node labeled “A:C1” among nodes 920 could correspond to the category labeled ISP among the categories 902.

The interface includes several selectable items 903, where an item labeled “ISP-Africa” is currently selected, and other items such as “ISP-Central America”, “ISP_Central America”, etc., can be selected next. For example, the node labeled “A:C1:1” among the nodes 930 could correspond to the item labeled “ISP-Africa”.

The center panel 904 of the interface displays the contents of the selected item. For example, since the selected item in FIG. 12 is “ISP-Africa”, the center panel 904 displays the contents of the ISP-Africa item. In this example, the selected item includes a text and an image.

The interface may also present one or more tasks 905 that are associated with the selected item. These tasks 905 may be assigned to individuals and groups with due dates and deadlines. The tasks 905 may be represented as a collection in the database.

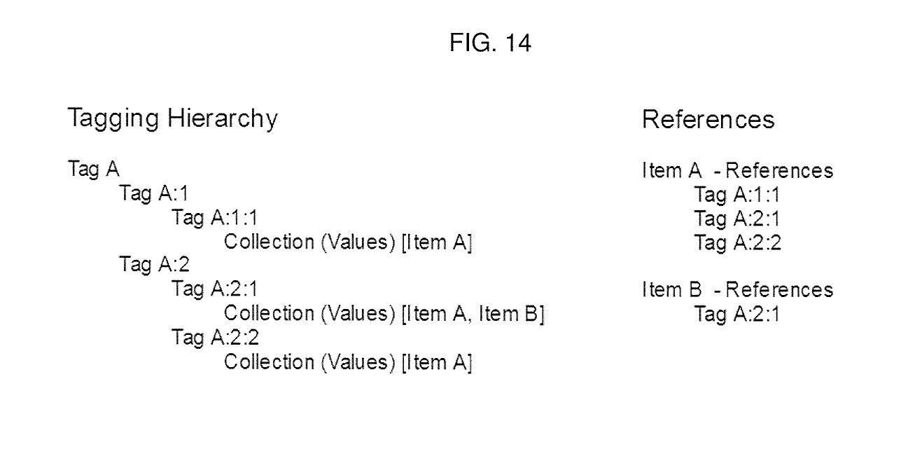

A tag section 906 of the interface enables a user to tag documents and files with metadata and other keywords. Content can also be tagged using geo-coded locations. This tagging allows for advanced search and filtering options, which makes finding files easy and efficient. FIG. 14 shows an example of how tags could be organized in the database and linked to items. For example, assume a contact tag is represented by a node labeled “Tag A”, sub-contact tags associated with a personal address and a business address are represented by nodes labeled “Tag A:1” and “Tag A:2”, respectively, a sub-personal address tag associated with a name is represented by a node labeled “Tag A:1:1, and sub-business address tag associated with a street and a state are represented by leaf nodes labeled “Tag A:2:1”, and “Tag A:2:2”, respectively. For example, leaf node “Tag A:1:1” includes a collection and Item A, leaf node “Tag A:2:1” includes a collection and Items A and B, and left node “Tag A:2:2” includes a collection and Item A. For example, if Item A is “ISP-Africa”, and the user tagged the item with a personal name, a business street and a business state, it would reference tags “Tag A:1:1, Tag A:2:1, and Tag A:2:2”. For example, if Item B is ISP-Central America”, and the user tagged the item with only a business street, it would only reference tag “Tag A:2:1”.

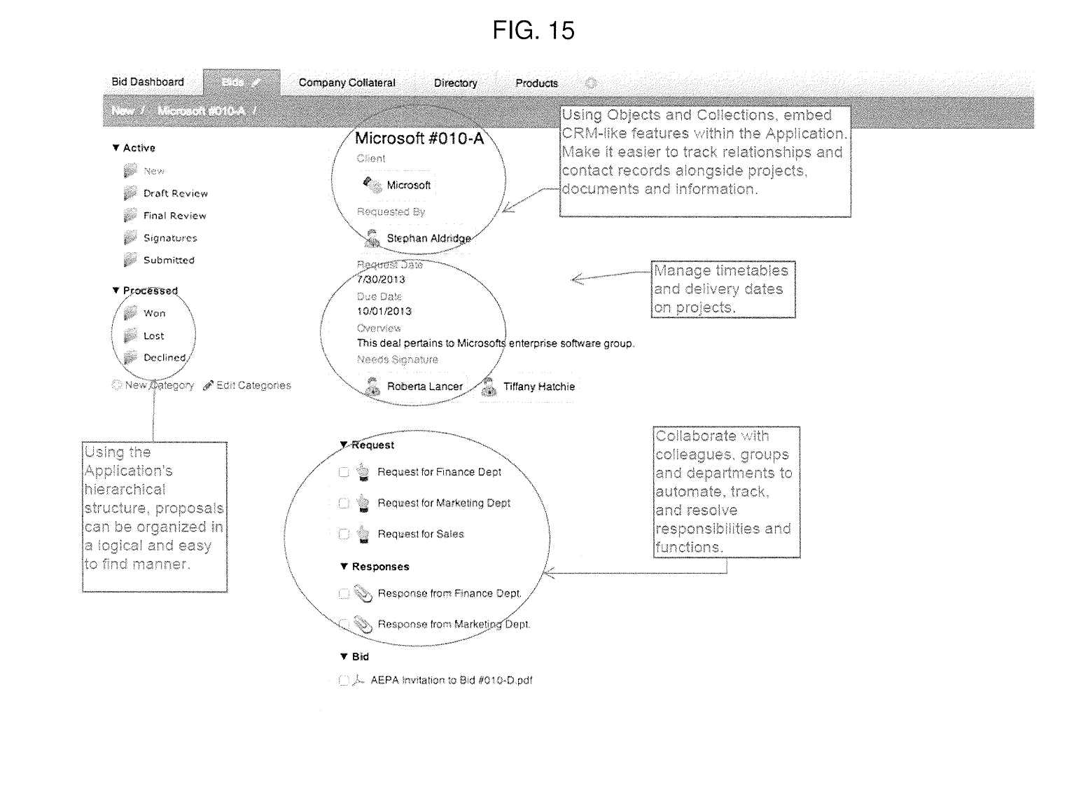

FIG. 15 shows another example of an interface application. As shown in FIG. 15, the selected tab is labeled “Bids”, and includes categories such as “Active” and “Processed”, where each category includes several items. For example, the selected item “new” causes the center panel 904 to present the contents of the item. The item in this case represents a new bid, which when represented as an object includes various fields (e.g., client, “requested by”, “request date”, “due date”, etc. The item includes one or more collections (e.g., a request collection, a responses collection, etc.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

It is to be understood that exemplary embodiments disclosed above are illustrative only, as the invention may be modified and practiced in different but equivalent manners apparent to those skilled in the art having the benefit of the teachings herein. It is therefore evident that exemplary embodiments disclosed herein may be altered or modified and all such variations are considered within the scope and spirit of the invention.

1. A database system comprising:
a memory storing a computer program;
a database comprising a tree graph, where the tree graph is a tree comprising a plurality of nodes, wherein each node includes a literal identifier (ID) that refers to an instance of one of a plurality of types of data structures and a node ID that uniquely distinguishes the node from the remaining nodes in the tree; and
a processor configured to execute the program,
wherein the program is configured to:
receive a query from a user comprising one of the instances;
process the query by traversing the tree to each node having a same literal ID that corresponds to the instance in the query; and
generate a query result based on children nodes of each node traversed to.

2. The database system of claim 1, wherein the result is an intersection of the literal IDs of the children nodes.

3. The database system of claim 1, wherein the program allows the literal IDs of two or more of the nodes to be the same as one another, and each of the two or more nodes to have different parents, respectively.

4. The database system of claim 3, wherein the query result is further based on the parents.

5. The database system of claim 1, wherein the program copies data within the tree by creating a new node with the same literal ID as an existing one of the nodes, and with a parent node that differs from the existing node.

6. The database system of claim 1, wherein each instance comprises parameters, read methods to retrieve the parameters, and write methods to write the parameters.

7. The database system of claim 6, wherein the program generating the query result comprises:
determining the literal ID of one of the children nodes;
determining the instance corresponding to the determined literal ID; and
using the read methods of the instance to retrieve at least one of the parameters.

8. The database system of claim 1, wherein a first part of the tree is stored on a first computer and a second other part of the tree is stored on a second computer, and the computers are configured to communicate with one another across a network.

9. The database system of claim 8, wherein the program includes a table that links the parts together.

10. The database system of claim 1, wherein the program enables a user to associate one of the literal IDs with a set of literal IDs, and whenever the program creates a new node in the tree comprising the one literal ID, the program also creates additional nodes comprising the set of literal IDs.

11. The database system of claim 1, wherein the program is configured to associate a level of access with one of the nodes, and a user with a security level below the associated level is prevented from accessing the one node and all children nodes below the one node.

12. A method of performing a query on a database comprising a tree graph, where the tree graph is a tree comprising a plurality of nodes, wherein each node includes a literal identifier (ID) that refers to an instance of one of a plurality of types of data structures and a node ID that uniquely distinguishes the node from the remaining nodes in the tree, the method comprising:
receiving a query from a user comprising one of the instances;
traversing the tree to each node having a same literal ID that corresponds to the instance in the query; and
generating a query result based on children nodes of each node traversed to.

13-22. (canceled)

23. A content management system comprising:
a memory storing a computer program;
a database comprising a tree graph, where the tree graph is a tree comprising a plurality of nodes, wherein each node includes a literal identifier (ID) that refers to an instance of one of a plurality of types of data structures and a node ID that uniquely distinguishes the node from the remaining nodes in the tree; and
a processor configured to execute the program,
wherein the program is configured to present a user interface comprising a selectable tab represented as a first one of the nodes and the selectable tab comprises a visible item represented as a second one of the nodes descended from the first node.

24. The content management system of database system of claim 1, wherein the program allows the literal IDs of two or more of the nodes to be the same as one another, and each of the two or more nodes to have different parents, respectively.

25. The content management system of claim 23, wherein the item is a document.

26. The content management system of claim 23, wherein the document comprises text and an image.

27. The content management system of claim 23, wherein the selectable tab comprises a category, the item is displayed below the category, the category is represented as a third one of the nodes as a child of the first node and a parent of the second node.

28. The content management system of claim 23, wherein the user interface includes a pane for adding a task associated with the item.

29. The content management system of claim 23, wherein the user interface includes a pane for tagging the item with metadata.
